(19) United States
(12) Patent Application Publication
(10) Pub. No.: US 2019/0051033 A1
(43) Pub. Date: Feb. 14, 2019

(54) SYSTEM AND METHOD FOR OBJECT DIFFERENTIATION IN THREE-DIMENSIONAL SPACE

(71) Applicant: SUPERB REALITY LTD., Tel Aviv (IL)

(72) Inventor: Eran Eilat, Beit Shean (IL)

(73) Assignee: SUPERB REALITY LTD., Tel Aviv (IL)

(21) Appl. No.: 16/078,107

(22) PCT Filed: Feb. 22, 2017
(86) PCT No.: PCT/IL2017/050221

§ 371 Date: Aug. 21, 2018

Related U.S. Application Data
(60) Provisional application No. 62/299,352, filed on Feb. 24, 2016.

(51) Int. Cl. G06T 15/00; G06K 9/00; G06K 9/20

(52) U.S. Cl. CPC G06T 15/005; G06K 9/2018; G06K 9/00201

(57) ABSTRACT

The disclosure relates to systems and methods for differentiating for a user, closer objects from other objects by reducing the radiation reflection of objects beyond a certain distance, to below the detection limit of the sensor used to detect the reflection.

### BACKGROUND

The disclosure is directed to a system and method for differentiating objects viewed on a display that are close, from objects that are in the background. Specifically, the disclosure is directed to systems and methods for differentiating for a user, closer objects from other objects by reducing the radiation reflection of objects beyond a certain distance, to below the detection limit of the sensor used to detect the reflection.

For various application, for example, virtual reality (VR) it may be important to resolve objects such as the hand of the user, from other objects in the environment.

Currently, typical resolution of closer objects is done using stereotactic cameras, as well as 3D (three dimensional) cameras with depth sensors, in conjunction with various algorithms that are computation heavy, requiring substantial processing power, creating delays and lag during the rendering stage. Moreover, the algorithms are typically unreliable. Such solutions also require additional hardware and software, imposing additional costs and complication on the final product, and reducing fault tolerance on the final product.

There is therefore a need to minimize reflection of non-essential objects to the VR tasks using simpler controls without the need for additional hardware.

### SUMMARY

Disclosed, in various embodiments, are assemblies, system and method for differentiating objects viewed on a display that are close, from objects that are in the background.

More specifically, provided herein is a system for differentiating objects close to a user from other objects in a three dimensional space comprising: an electromagnetic radiation (EMR) source; means for detecting electromagnetic radiation reflected from objects in the three-dimensional space; a display; and a processor, in communication with the EMR source, the means for detecting EMR and the display, operably coupled to a memory having a processor-readable medium thereon with a set of executable instructions configured to: control the EMR source to emit EMR at a given wavelength and intensity; control the means for detecting EMR to reduce reflectance of objects in the three-dimensional space that are beyond a predetermined distance to below the detection threshold of the EMR detection means; and control the display to render only those objects with EMR reflectance above the detection threshold of the EMR detection means.

In another embodiment provided herein is a method of differentiating objects close to a user from other objects in a three dimensional space implementable in the systems described and claimed herein, comprising: directing the EMR source towards the three dimensional space; using the processor, executing instructions to reduce reflectance of objects in the three-dimensional space that are beyond a predetermined distance to below the detection threshold of the EMR detection means and displaying only those objects with EMR reflectance above the detection threshold of the EMR detection means.

These and other features of the assemblies, system and method for differentiating objects viewed on a display that are close, from objects that are in the background, will become apparent from the following detailed description when read in conjunction with the figures and examples, which are exemplary, not limiting.

### BRIEF DESCRIPTION OF THE FIGURES

For a better understanding of the assemblies system and method for differentiating objects viewed on a display that are close, from objects that are in the background described, with regard to the embodiments thereof, reference is made to the accompanying examples and figures, in which:

FIG. 1 illustrates a schematic depicting the reflectance difference of objects closer to a viewer from those further away;

FIG. 2 illustrates a display of a three dimensional space without the differentiating systems and methods described; and

FIG. 3 illustrates a display of the same three dimensional space when implementing the methods described using the systems provided.

### DETAILED DESCRIPTION

Provided herein are embodiments of assemblies, systems and methods for differentiating for a user, closer objects from other objects by reducing the radiation reflection of objects beyond a certain distance, to below the detection limit of the sensor used to detect the reflection.

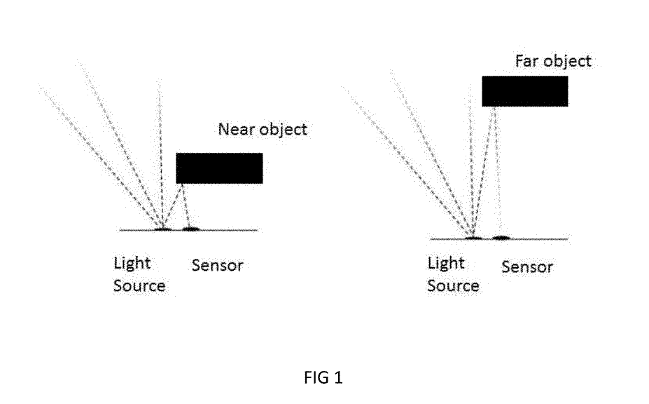

In an embodiment, the systems and methods described herein invention enable separation of objects that are close to the device viewer by, for example, illuminating the environment and configuring the image sensor parameters, namely focus, exposure, gamma, and/or white balance in a way that the light reflected back from the object that is close to the viewer, will be registered (in other words, detected with priority) significantly by the image sensor, and light reflected from far objects will be mostly attenuated. As illustrated in FIG. 1, since light and other electromagnetic radiation (EMR) attenuates at an exponential rate with distance (factor of 1/r²). Accordingly, the closer an object is to a light source, depending on the object's material composition reflectance profile (or reflectance coefficient), the higher proportion of the light transmitted it will reflect. As used herein, the term “reflectance profile” refers in an embodiment, to the representation of the frequency and intensity of radiation detected by a detector following at least one reflectance of the radiation from the object's surface. Moreover, the term “reflecting surface” means a surface capable of reflecting incident radiation. Reflection from a reflecting surface need not be total and it is contemplated that some incident radiation can interact with a material disposed in a space outside the material embodying a reflecting surface. Likewise, the term “reflectance coefficient” e.g., as it relates to the reflection of radiation incident on a surface forming a boundary between two regions having different indices of refraction, is defined in an embodiment, as the ratio of the intensity (at a given wavelength) of light reflected at a boundary surface relative to the intensity of the radiation incident on that surface in accordance with the following relation:

$$a = \frac{{l}_{r}}{{l}_{0}}$$

Wherein: α denotes the reflectance coefficient,
I₀ denotes the intensity of the incident radiation, and
Iᵣ denotes the intensity of portion of the incident radiation that is reflected.

In an embodiment, using the refraction coefficient, the processor control the means for detecting EMR to reduce reflectance of objects in the three-dimensional space that are beyond a predetermined distance to below the detection threshold of the EMR detection means.

Accordingly and in an embodiment, provided herein is a system for differentiating objects close to a user (e.g., the user's hand) from other objects that are further away and may not be essential to the desired scene in a three dimensional space comprising: an electromagnetic radiation (EMR) source; means for detecting electromagnetic radiation reflected from objects in the three-dimensional space; a display; and a processor, in communication with the EMR source, the means for detecting EMR and the display, operably coupled to a memory having a processor-readable medium thereon with a set of executable instructions configured to: control the EMR source to emit EMR at a given wavelength and intensity; control the means for detecting EMR to reduce reflectance of objects in the three-dimensional space that are beyond a predetermined distance to below the detection threshold of the EMR detection means; and control the display to render only those objects with EMR reflectance above the detection threshold of the EMR detection means.

In an embodiment, the system can be configured to operate on external power supply or run autonomously with internal power source. A person skilled in the art would readily recognize that the external power source does not necessarily need to be inside a housing, or for that matter, dedicated to the system. The external power source can be, for example, a vehicle battery, an electric generator, a portable battery pack, the electric power grid and the like power sources currently known or later developed.

With the advent of small, low power stand-alone electronic type cameras for the detection of visible, near-infrared (VNIR) and long-wave infrared (LWIR) images (such as the conventional image-intensified CMOS imager for VNIR image detection and the uncooled micro-bolometer focal plane array (FPA) imager for LWIR image detection), the number of applications for these types of VNIR or LWIR cameras to include hand-held, portable and glasses, and/or helmet-mounted applications has expanded. Accordingly and in another embodiment, the systems for discerning, delineating and differentiating objects that are close to the user, from background objects provided herein, can comprise a charge-coupled device (CCD) camera, complementary metal-oxide semiconductor (CMOS) camera, a visible near infrared (VNIR) imaging sensor or hyperspectral camera with detection capabilities at wavelengths between about 400 nm and about 1000 nm, a near infrared (NIR) sensor with detection capabilities at wavelengths between about 700 nm and about 2.5 μm, a long wave infrared radiation (LWIR) imaging sensor with detection capabilities at wavelengths between about 2.0 μm and about 13 μm, a thermal imaging unit (e.g., micro-bolometer FPA), an IR illuminator, or means for detecting electromagnetic radiation comprising one or more of the foregoing. The system can have more than one channel that retrieve electromagnetic radiation of different wavelengths for example, one channel configured to sense and capture a scene at wavelengths between about 380 nm and about 750 nm (e.g., VNIR image sensor), and a second channel configured to sense and capture a scene at wavelengths between about 7 μm and about 14 μm (e.g., LWIR), and after processing, feed or transmit the video image to the display: either each of the channels separately or the superimposed result. The determination can depend on the reflectance profile of the three dimensional space where the closer objects are sought to be resolved.

In addition, the systems described can further comprise frame grabber (referring to any device capable of capturing digital information from a video source), the frame grabber being used for digitizing the signal from the means for detecting electromagnetic radiation at a predetermined rate of frames per second (FPS). The frame grabber can be configured to capture signals at a rate of between about 22 and about 150 FPS, for example, at a rate of about 28 to about 36 FPS. For example, the frame grabber can also be a frame threshold suppressor circuit. The frame grabber can be any device and process whereby an image is saved in memory as a series of digital values. For example, the type of EMR detector used may determine to some extent what type of frame grabbers may be suitable. Thus, the claimed invention is not limited to any particular frame grabber mechanism.

The system can be operated and linked to a wearable device using any appropriate linking means, including but not limited to wireless, wire line, optical fiber, cable (e.g., RS232, Ethernet), RF, Blue Tooth etc., or any suitable combination of the foregoing. The program code for carrying out operations for aspects of the present disclosure may be written in any combination of one or more programming languages, including an object oriented programming language such as Java™, Smalltalk, C++, Python or the like and conventional procedural programming languages, such as the “C” programming language or similar programming languages. The program code of the executable instructions disclosed, may be executed entirely on the processor, partly on the processor, or partly on the processor and partly on a remote processor, or entirely on a remote computer or server.

Furthermore, the disclosed and claimed technology or type of components can be configured to address requirements of low cost. Further, the proposed approach can even be extended to a wearable (helmet mounted, head mounted) version of the system, such as goggles. In addition, the devices, systems and methods disclosed and claimed can be configured to be user transformable—by easily installing uniform add-ons, keypad, display, eyepiece and connectivity ports, range finders, transceivers, or a combination of add-ons and peripherals comprising the foregoing. It should be noted, that display does not necessarily need to be fixed to any housing and could be located remotely and in general, can be operably coupled to the device.

The EMR source, can be a light emitting diode, or LED having an intensity of between about 500 and about 15,000 lumens. Moreover, wherein the LED can likewise be a strobe or, alternatively, be configured to operate intermittently and the processor can further have a set of instructions thereon configured to vary the frequency and duration of light emission from the LED, as well as, in another embodiment, the wavelength (e.g., using filters) and intensity of the emitted EMR, to optimize for the three dimensional space's reflectance profile.

The term “communicate” (and its derivatives e.g., a first component, e.g., the processor “communicates with” or “is in communication with” a second component, e.g., the reflected EMR detection means) and grammatical variations thereof are used to indicate a structural, functional, mechanical, electrical, optical, or other relationship, or any combination thereof, between two or more components or elements. As such, the fact that one component is said to communicate with a second component is not intended to exclude the possibility that additional components can be present between, and/or operatively associated or engaged with, the first and second components. Furthermore, the term “electronic communication” means that one or more components of the systems and methods for resolving objects distance from a user described herein are in wired or wireless communication or internet communication so that electronic signals and information can be exchanged between the components.

Likewise, the term “module”, for example, a control module, a display module, an imaging module and their combination used in the systems described, is understood to encompass a tangible entity, be that an entity that is physically constructed, specifically configured (e.g., hardwired), or temporarily (e.g., transitorily) configured (e.g., programmed) to operate in a specified manner or to perform part or all of any operation of the methods described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time. In an embodiment, an electronic control unit of the systems disclosed and claimed, is the system's processor.

The processor or control module can be configured to control a plurality of parameters associated with the means for detecting reflected EMR. These parameters can be but are not limited to: focus, field depth, exposure, auto-exposure, exposure compensation, gamma-correction, White-balance, auto White-balance, DIN, ISO, or a combination of parameters comprising one or more of the foregoing. For example, Gamma correction can normally be achieved by first converting the detected reflectance signal into its logarithm, then multiplying this signal by the desired correction factor G associated with the desired distance resolution, and finally applying the resultant corrected signal to an exponential or anti-logarithm converter. Similarly, the means for detecting reflected EMR refer to an electronic component which can sense or otherwise respond to radiation at a targeted wavelength or spectrum of wavelengths. As indicated, radiation may be within the visible-light spectrum or outside the visible-light spectrum (UV or IR). Photodetectors, IR sensors, biosensors, and photovoltaic cells are examples of radiation-responsive components.

In addition, the processor can be configured to vary the focus of the various reflected EMR detection means. These detection means can be, for example cameras. Other EMR detection means can be junction field-effect transistors or JFET's, generally formed on monocrystalline semiconductor materials, such as silicon for example. Other electromagnetic radiation detection mean can be a diode, associated with an impedance matching circuit or an input stage, designed essentially to polarize the diode and collect the charges that are generated in it by EMR. The detection means, can be adapted to convert electromagnetic radiation, for example visible near infrared light, or y radiation, into a current of electrical charges. In an embodiment and as described herein, the wavelength used in the methods and systems provided may be varied to achieve the best resolution of close objects that will assist in the differentiation of those object from the three dimensional surroundings. The wavelength may be changed anywhere between about 0.24μ and about 30μ, specifically, between about 0.3μ and about 2.4 m μ, more specifically, between about 0.35μ and about 0.92μ. Likewise, the EMR detection means can be multi-spectral detection systems, i.e. adapted to detect several different wave-length ranges, for example, from a stack of epitaxial layers. Other means can utilize dispersive optical devices (e.g., prism and diffraction grating) or narrow band filters to separate lights of different wavelengths, and then use an array detector to record (and integrate) them separately. Furthermore, Fourier spectroscopy technique, which uses an interferometer to divide the reflected beam into two halves, and change their optical path difference, can be used to to generate varying interference intensities at each spatial point. Then spectral information can be extracted by applying Fourier transform to these intensities measured by an array detector. These means and their equivalents are contemplated herein.

Varying the focus to a shorter focal length and a longer focal length and collecting the reflected EMR from objects within the three dimensional space, can be used as reference for resolving objects closer to the viewer, from non-essential background objects. In an embodiment, in a calibration phase, the control module can alter the focal length for a predetermined time period at a frequency that at least double (twice) the FPS used for the rendering stage on the display. In other words, for each frame captured, information on reflectance of (passive) objects can be obtained at two focal lengths.

Likewise, the control module can control a strobe LED used in the systems described (or, alternatively, if the LED is configured to operate intermittently, the frequency at which the LED operates and emits light) in a calibration mode, where, at a given wavelength and intensity, the EMR source is operated as strobe at a frequency that is at least double that of the captured FPS using the frame grabber.

In an embodiment, the methods described are implemented on the systems provided hereinabove. Accordingly and in an embodiment, provided herein is a method of differentiating objects close to a user from other objects in a three dimensional space implementable in the systems described and claimed herein, comprising: directing the EMR source towards the three dimensional space; using the processor, executing instructions to reduce reflectance of objects in the three-dimensional space that are beyond a predetermined distance to below the detection threshold of the EMR detection means and displaying only those objects with EMR reflectance above the detection threshold of the EMR detection means.

In certain embodiments, the step of executing instructions is preceded by a step of calibrating the reflected EMR detection means. For example, varying the EMR emission at a rate double that of the predetermined FPS; and using the frame grabber, storing the digitized values of the signals obtained from the reflected EMR detection means as reference in the memory of the system. Likewise, the methods described can alternatively or in addition comprise varying the focus of reflected EMR detection means at a rate double that of the predetermined FPS; and using the frame grabber, storing the digitized values of the signals obtained from the reflected EMR detection means or in other words, collecting reflected EMR signal from the three-dimensional space and/or objects.

Using the methods described herein, it is possible then to provide the user with feedback on a close object exceeding distance limit, whereby reflected EMR signal is below the detection limit of the reflected EMR detection means. In other words, once the user, for example moves an object manipulated in virtual reality outside a desired range, the system can detect that event and turn the closer object (e.g., the user's hand) red or provide audible signal to the user. Similarly, the system can further be used to differentiate posture (elevation, rotation and yaw of the object or hand) and/or gesture (e.g., capturing objects in VR environment) of the hand.

As indicated above, the step of executing instructions to reduce reflectance of objects in the three-dimensional space comprises; emitting EMR towards the three dimensional space; and eliminating auto-exposure, and/or eliminating auto White-balance, and/or reducing DIN and/or ISO (and/or ASA), and/or correcting gamma balance.

The terms “first,” “second,” and the like, when used herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the signal(s) includes one or more signal). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

In addition, for the purposes of the present disclosure, directional or positional terms such as “top”, “bottom”, “upper,” “lower,” “side,” “front,” “frontal,” “forward,” “rear,” “rearward,” “back,” “trailing,” “above,” “below,” “left,” “right,” “radial,” “vertical,” “upward,” “downward,” “outer,” “inner,” “exterior,” “interior,” “intermediate,” etc., are merely used for convenience in describing the various embodiments of the present disclosure.

The term “coupled”, including its various forms such as “operably coupled”, “coupling” or “coupleable”, refers to and comprises any direct or indirect, structural coupling, connection or attachment, or adaptation or capability for such a direct or indirect structural or operational coupling, connection or attachment, including integrally formed components and components which are coupled via or through another component or by the forming process (e.g., an electromagnetic field). Indirect coupling may involve coupling through an intermediary member or adhesive, or abutting and otherwise resting against, whether frictionally (e.g., against a wall) or by separate means without any physical connection.

The term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All ranges disclosed herein are inclusive of the endpoints, and the endpoints are independently combinable with each other. Likewise, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

A more complete understanding of the components, processes, assemblies, and devices disclosed herein can be obtained by reference to the accompanying drawings. These figures (also referred to herein as “FIG.”) are merely schematic representations (e.g., illustrations) based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

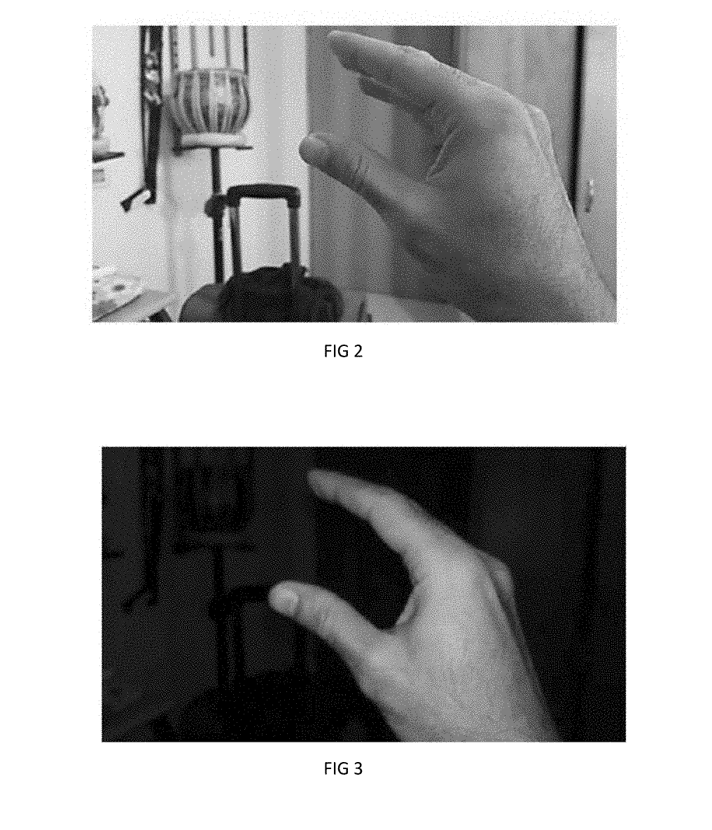

Turning now to FIG. 2, illustrating a three-dimensional scene before using the systems and methods for manipulating the display to resolve objects (e.g., user's hand) from non-essential objects in the background, while FIG. 3 illustrates the same scene after implementing the methods using the systems provided.

Thus provided herein is a A system for differentiating objects close to a user from other objects in a three dimensional space comprising: an electromagnetic radiation (EMR) source; means for detecting electromagnetic radiation reflected from objects in the three-dimensional space; a display; and a processor, in communication with the EMR source, the means for detecting EMR and the display, operably coupled to a memory having a processor-readable medium thereon with a set of executable instructions configured to: control the EMR source to emit EMR at a given wavelength and intensity; control the means for detecting EMR to reduce reflectance of objects in the three-dimensional space that are beyond a predetermined distance to below the detection threshold of the EMR detection means; and control the display to render only those objects with EMR reflectance above the detection threshold of the EMR detection means, wherein (i) the means for detecting EMR radiation is a charge-coupled device (CCD) camera, complementary metal-oxide semiconductor (CMOS) camera, a visible near infrared (VNIR) imaging sensor, a near infrared sensor, a long wave infrared radiation (LWIR) imaging sensor or means for detecting electromagnetic radiation comprising one or more of the foregoing, further (ii) comprising a frame grabber, the frame grabber being used for digitizing the signal from the means for detecting electromagnetic radiation at a predetermined rate of frames per second (FPS), wherein (iii) the EMR source is a light emitting diode (LED), (iv) configured to operate intermittently and wherein the processor is further configured to vary the frequency and duration of light emission from the LED, wherein (v) the processor is configured to control a plurality of parameters associated with the means for detecting reflected EMR, such as, for example, (vi) focus, field depth, exposure, auto-exposure, exposure compensation, gamma-correction, white-balance, auto white-Balance, DIN, ISO, brightness, or a combination of parameters comprising one or more of the foregoing, wherein (vii) the processor is configured to vary the focus of the means for detecting reflected EMR at a predetermined rate (in other words zoom in and fade out), wherein (viii) the intermittent light emission rate and/or rate of varying the focus on the reflected EMR is at least double the predetermined rate of frames per second (FPS), and further provide (ix), a mobile communication device, or a combination thereof, comprising the systems described herein.

IN another embodiment, provided herein is a method of differentiating objects close to a user from other objects in a three-dimensional space implementable in the systems described herein, the method comprising: directing the electromagnetic radiation (EMR) source towards the three-dimensional space; using the processor, executing instructions to reduce reflectance of objects in the three-dimensional space that are beyond a predetermined distance to below the detection threshold of the EMR detection means; and displaying only those objects with EMR reflectance above the detection threshold of the EMR detection means, wherein (x) the step of executing instructions is preceded by a step of calibrating the reflected EMR detection means, by (xi) varying the EMR emission at a rate of at least double that of the predetermined FPS; and using the frame grabber, storing the digitized values of the signals obtained from the reflected EMR detection means, alternatively or in addition: (xii) varying the focus of reflected EMR detection means at a rate of at least double that of the predetermined FPS; and using the frame grabber, storing the digitized values of the signals obtained from the reflected EMR detection means, wherein (xiii), wherein the step of executing instructions to reduce reflectance of objects in the three-dimensional space comprises; emitting EMR towards the three-dimensional space; and eliminating auto-exposure, and/or eliminating auto white-balance, and/or reducing DIN and/or ISO, and/or correcting gamma balance, wherein (xiv) the step of calibration comprises collecting reflected EMR signal from the three-dimensional space and/or objects, further comprising (xv) providing the user feedback on a close object exceeding distance limit, whereby reflected EMR signal is below the detection limit of the reflected EMR detection means, wherein (xvi) the closer object is the hand of the user, wherein (xvii) the method further differentiates posture and/or gesture of the hand, and further comprising (xviii) providing virtual reality objects into the displayed three-dimensional space.

The present technology is described systems and methods for differentiating for a user, closer objects from other objects by reducing the radiation reflection of objects beyond a certain distance, to below the detection limit of the sensor used to detect the reflection. It will be understood, however, that the description provided hereinabove is merely illustrative of the application of the principles of the disclosed and claimed technology, the scope of which is to be determined by the claims viewed in light of the specification and figures. Other variants and modifications of the disclosed technology will be readily apparent to those skilled in the art.

1. A system for differentiating objects close to a user from other objects in a three-dimensional space comprising:
a. an electromagnetic radiation (EMR) source;
b. means for detecting electromagnetic radiation reflected from objects in the three-dimensional space;
c. a display; and
d. a processor, in communication with the EMR source, the means for detecting EMR and the display, operably coupled to a memory having a processor-readable medium thereon with a set of executable instructions configured to:
i. control the EMR source to emit EMR at a given wavelength and intensity;
ii. control the means for detecting EMR to reduce reflectance of objects in the three-dimensional space that are beyond a predetermined distance to below the detection threshold of the EMR detection means; and
iii. control the display to render only those objects with EMR reflectance above the detection threshold of the EMR detection means.

2. The system of claim 1, wherein the means for detecting EMR radiation is a charge-coupled device (CCD) camera, complementary metal-oxide semiconductor (CMOS) camera, a visible near infrared (VNIR) imaging sensor, a near infrared sensor, a long wave infrared radiation (LWIR) imaging sensor or means for detecting electromagnetic radiation comprising one or more of the foregoing.

3. The system of claim 2, further comprising a frame grabber, the frame grabber being used for digitizing the signal from the means for detecting electromagnetic radiation at a predetermined rate of frames per second (FPS).

4. The system of claim 3, wherein the EMR source is a light emitting diode (LED).

5. The system of claim 4, wherein the LED is configured to operate intermittently and wherein the processor is further configured to vary the frequency and duration of light emission from the LED.

6. The system of claim 5, wherein the processor is configured to control a plurality of parameters associated with the means for detecting reflected EMR.

7. The system of claim 6, wherein the plurality of parameters are: focus, field depth, exposure, auto-exposure, exposure compensation, gamma-correction, white-balance, auto white-Balance, DIN, ISO, brightness, or a combination of parameters comprising one or more of the foregoing.

8. The system of claim 7, wherein the processor is configured to vary the focus of the means for detecting reflected EMR at a predetermined rate.

9. The system of claim 8, wherein the intermittent light emission rate and/or rate of varying the focus on the reflected EMR is at least double the predetermined rate of FPS.

10. A wearable device, a mobile communication device, or a combination thereof, comprising the system of claim 1.

11. A method of differentiating objects close to a user from other objects in a three-dimensional space implementable in the system of claim 10, comprising:
a. directing the electromagnetic radiation (EMR) source towards the three-dimensional space; b. using the processor, executing instructions to reduce reflectance of objects in the three-dimensional space that are beyond a predetermined distance to below the detection threshold of the EMR detection means: and
c. displaying only those objects with EMR reflectance above the detection threshold of the EMR detection means.

12. The method of claim 11, wherein the step of executing instructions is preceded by a step of calibrating the reflected EMR detection means.

13. The method of claim 12, comprising:
a. varying the EMR emission at a rate of at least double that of the predetermined FPS; and
b. using the frame grabber, storing the digitized values of the signals obtained from the reflected EMR detection means.

14. The method of claim 13, alternatively or in addition:
a. varying the focus of reflected EMR detection means at a rate of at least double that of the predetermined FPS; and
b. using the frame grabber, storing the digitized values of the signals obtained from the reflected EMR detection means.

15. The method of claim 14, wherein the step of executing instructions to reduce reflectance of objects in the three-dimensional space comprises:
a. emitting EMR towards the three-dimensional space; and
b. eliminating auto-exposure, and/or eliminating auto white-balance, and/or reducing DIN and/or ISO, and/or correcting gamma balance.

16. The method of claim 14, wherein the step of calibration comprises collecting reflected EMR signal from the three-dimensional space and/or objects.

17. The method of claim 16, further comprising providing the user feedback on a close object exceeding distance limit, whereby reflected EMR signal is below the detection limit of the reflected EMR detection means.

18. The method of claim 17, wherein the closer object is the hand of the user.

19. The method of claim 18, wherein the method further differentiates posture and/or gesture of the hand.

20. The method of claim 19, further comprising providing virtual reality objects into the displayed three-dimensional space.
